(19) United States
(12) Patent Application Publication
(10) Pub. No.: US 2018/0275297 A1
(43) Pub. Date: Sep. 27, 2018

(54) Seismic-Source Apparatus And Detection System

(71) Applicant: Halliburton Energy Services, Inc., Houston, TX (US)

(72) Inventors: Brian Vandellyn Park, Spring, TX (US); Steven Robert Weiss, Tomball, TX (US); Norm R. Warpinski, Cypress, TX (US)

(21) Appl. No.: 15/763,969

(22) PCT Filed: Nov. 4, 2015
(86) PCT No.: PCT/US2015/058918

§ 371 Date: Mar. 28, 2018

(51) Int. Cl. G01V 1/143; G01V 1/50; F03G 1/02; F03G 1/08

(52) U.S. Cl. CPC G01V 1/143; G01V 1/50; G01V 2210/1299; F03G 1/08; F03G 1/02

(57) ABSTRACT

A source of acoustic energy for a downhole environment can include a motor and a mechanical energy storage device. The mechanical energy storage device may be for storing a preset amount of torque generated by the motor. The source can also include a rigid body moveable between a retracted position and an extended position by the mechanical energy storage device. The rigid body may be for releasing the acoustic energy into the downhole environment in response to the mechanical energy storage device releasing the preset amount of torque generated by the motor and moving the rigid body to the extended position.

### TECHNICAL FIELD

The present disclosure relates generally to apparatus and systems for analyzing a subterranean formation. More specifically, but not by way of limitation, this disclosure relates to producing and measuring acoustic energy from a within a wellbore.

### BACKGROUND

A well system (e.g., oil or gas wells for extracting fluids from a subterranean formation) can include a wellbore drilled into a formation. Knowledge regarding the properties and conditions of the wellbore and the surrounding formation can improve the operation of the well. Sources for producing acoustic energy within the wellbore and receivers positioned outside the wellbore for monitoring the acoustic energy produced can be used to monitor conditions within the wellbore and the surrounding formation.

### BRIEF DESCRIPTION OF THE DRAWINGS

FIG. 1 is a schematic illustration of a seismic-source and a seismic detection system according to one aspect of the present disclosure.

FIG. 2 is a perspective view of an actuation mechanism of the seismic-source of FIG. 1, according to one aspect of the present disclosure.

FIG. 3 is perspective view of a seismic-source with multiple actuation mechanism in a retracted position, according to another aspect of the present disclosure.

FIG. 4 is perspective view of the seismic-source of FIG. 3 with the multiple actuation mechanism in an extended position, according to an aspect of the present disclosure.

FIG. 5 is perspective view of a seismic-source that includes multiple actuation mechanisms positioned in series, according to another aspect of the present disclosure.

FIG. 6 is a block diagram of a seismic-source and detection system, according to an aspect of the present disclosure.

FIG. 7 is a block diagram depicting an example of a computing device for controlling a seismic-source, according to an aspect of the present disclosure.

### DETAILED DESCRIPTION

Certain aspects and examples of the disclosure are directed to an apparatus for a seismic-source and a system for monitoring the acoustic energy produced by the seismic-source. The seismic-source can be positioned within a casing. The seismic-source can include one or more actuation mechanisms for releasing acoustic energy downhole. The actuation mechanism can include a rigid body that can have a retracted position and an extended position. The rigid body may move from the retracted position to the extended position. The rigid body may also move from the extended position back to the retracted position. The rigid body can release acoustic energy by contacting a hard surface, for example a casing, when it is moved to the extended position. The rigid body can thereby repeatedly release acoustic energy by moving between the retracted and extended positions.

The rigid body can move between the retracted and extended position by way of a spring. The spring can be a torsion spring that may be coupled to a rod. The rigid body may also be coupled to the rod. The torsion spring can store energy as it is wound up. The rod and the rigid body can rotate and extend outwardly from a housing upon release of the torsion spring. An end of the rigid body can contact the casing, or other hard surface, when the rigid body extends outwardly from the housing. The actuation mechanism can include a motor that can wind the torsion spring. The motor can be coupled to the torsion spring via a planetary drive (or other reduction drive). To release the torsion spring, the planetary drive can decouple from the torsion spring via a solenoid.

The seismic-source can include multiple acoustic mechanisms. The actuation of the rigid body of each acoustic mechanism can be controlled to create acoustic energy having a desired direction, amplitude, or frequency. The seismic-source can be in communication with a computing device, for example a controller, at the surface via a communication link, for example a wireline. A microprocessor on the seismic-source can control each of the actuation mechanisms in response to instructions received from the controller at the surface.

One or more receivers can be positioned within the formation for monitoring the acoustic energy released by the seismic-source. In some aspects, the acoustic energy can include compressional waves (“P-waves”) and shear waves (“S-waves”). The receivers can monitor the arrival time of the P-waves and S-waves and may transmit that information to a computing device at the surface via a communication link. The computing device at the surface may also receive information regarding the seismic-source from the controller. Information regarding the seismic-source may be used together with the information regarding the arrival times of the P-waves and S-waves to determine a characteristic of the wellbore or the surrounding formation.

These illustrative aspects are given to introduce the reader to the general subject matter discussed here and are not intended to limit the scope of the disclosed concepts. The following sections describe various additional features and aspects with reference to the drawings in which like numerals indicate like elements, and directional descriptions are used to describe the illustrative aspects but, like the illustrative aspects, should not be used to limit the present disclosure.

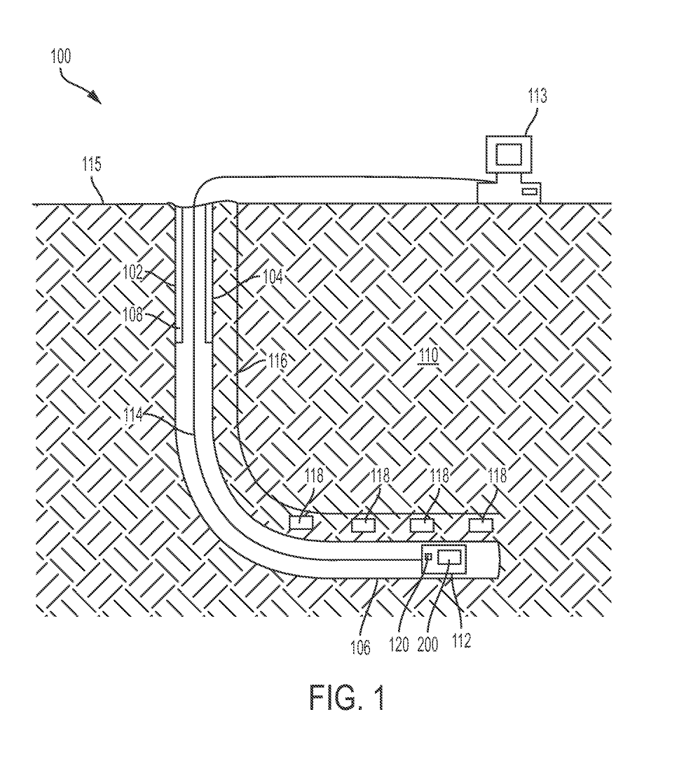

FIG. 1 is a schematic illustration of a seismic detection system 100 according to one aspect. A wellbore 102 extends through various earth strata. The active wellbore has a substantially vertical section 104 and a substantially horizontal section 106. The substantially vertical section 104 may include a casing string 108 cemented at an upper portion of the substantially vertical section 104. The substantially horizontal section 106 extends through a hydrocarbon bearing subterranean formation 110. A seismic-source, for example source 112, can be positioned within the wellbore 102. The source 112 can be a source of acoustic energy, for example a seismic vibration. The source 112 may be deployed into the wellbore 102 using a wireline 114. In some aspects, the source 112 may be deployed into the wellbore 102 using coiled tubing, via attachment to a drill string, or by using a slick-line with a pre-programmed emission cycle. In still yet other aspects, the source 112 may be pumped into the wellbore 102, though other suitable means for positioning the source 112 within the wellbore 102 may be used.

The source 112 can include one or more actuation mechanisms 200 that can produce acoustic energy. Various aspects of the seismic vibration produced by the source 112 can be controlled. For example, the source 112 may control one or all of the amplitude, direction, and timing of the seismic vibration. The actuation mechanism 200 of the source 112 can be actuated multiple times to produce repeated seismic vibrations. The seismic vibration produced by the source 112 can include both P-waves and S-waves.

The source 112 can include a microprocessor 120. The microprocessor 120 can include sensors for providing information on the orientation of the source 112. The information on the orientation of the source 112 can identify the position of each actuation mechanism 200. The microprocessor 120 can be communicatively coupled to a controller 113 at a surface 115 of the wellbore 102 via a wired communication link, for example the wireline 114. In some aspects the communication link can be slick-line or coiled tubing. The communication link can include interfaces such as Ethernet, USB, IEEE 1394, or a fiber optic interface. In some aspects, the communication link can be wireless and can include wireless interfaces such as IEEE 802.11, Bluetooth, or radio interfaces for accessing cellular telephone networks (e.g., transceiver/antenna for accessing a CDMA, GSM, UMTS, or other mobile communications network). The source 112 can also be powered from the surface 115 via a power line. In some aspects the communication link, for example the wireline 114, can also provide power to the source 112.

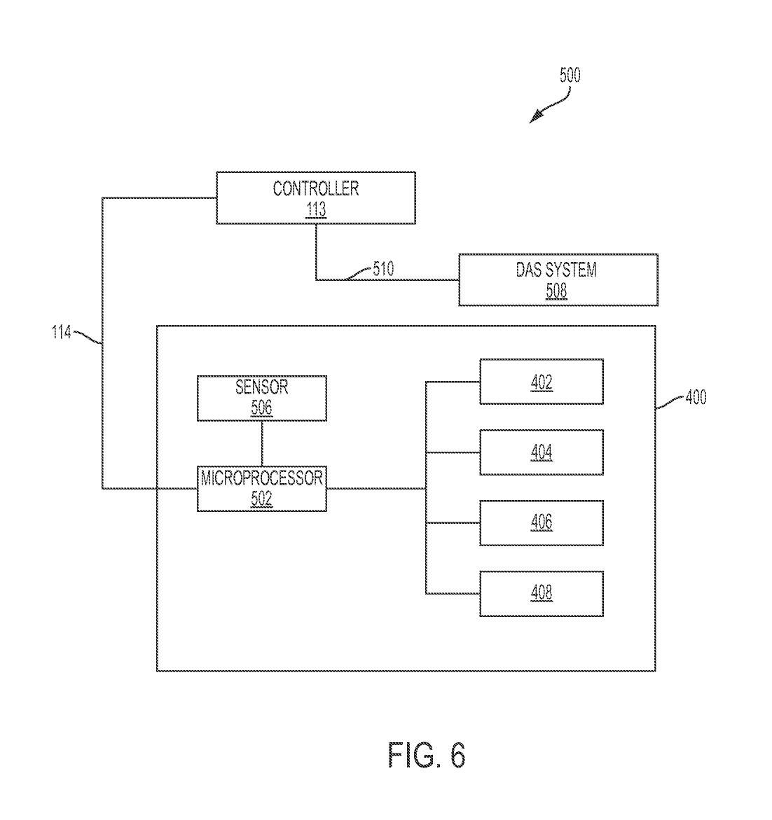

As described further with reference to FIG. 6, the controller 113 at the surface of the wellbore 102 can control the actuation or deployment of the actuation mechanisms 200 of the source 112. In some aspects, the controller 113 can control when each of the actuation mechanisms 200 is actuated to create a seismic vibration.

The system 100 can include multiple detectors (or sensors), for example seismic detectors 118. Seismic detectors 118 can be positioned within the formation 110 proximate to the wellbore 102. An optical fiber 116 may extend from the surface 105 into the formation 110 proximate to the seismic detectors 118. The optical fiber 116 and the seismic detectors 118 can be part of a Distributed Acoustic Sensing (“DAS”) system. The seismic detectors 118 can monitor and detect seismic waves produced by the source 112. The seismic detectors 118 can detect the arrival of the P-waves and the S-waves of a seismic vibration produced by the source 112. The seismic detectors 118 can be electro acoustic technology (“EAT”) sensors. EAT sensors can include an electronic sensor, for example a geophone. The EAT sensors can convert the electrical signal generated by the geophone in response to detecting the arrival of the P-waves and the S-waves into a frequency that may drive an acoustic signal. The acoustic signal may be detected by the optical fiber 116. The optical fiber 116 may transmit the acoustic signal to a computing device at the surface of the wellbore 102. The computing device at the surface can use the data received from the optical fiber 116 to determine the arrival times of the P-waves and S-waves associated with the seismic vibrations produced by the source 112. The P-waves and S-waves can travel at different velocities. Data regarding the arrival times of those waves can be used by the computing device to determine various characteristics of the wellbore and the formation, including but not limited to the amount of oil or water present in the formation.

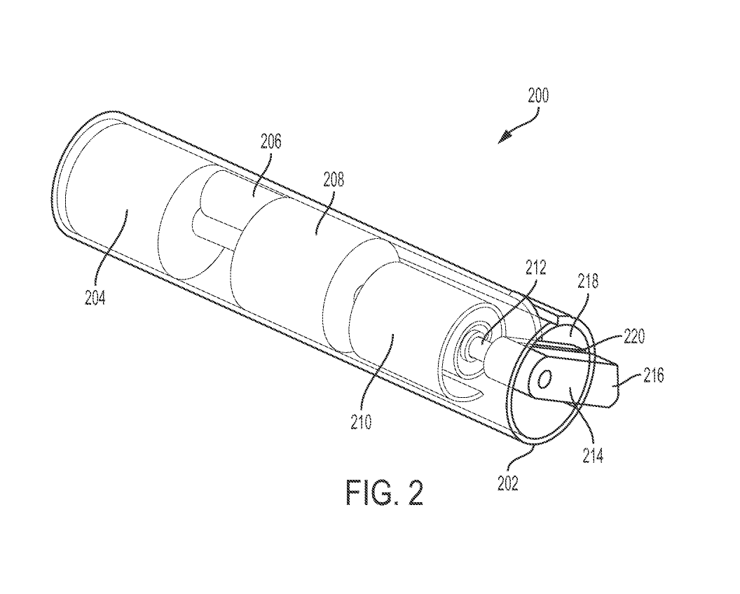

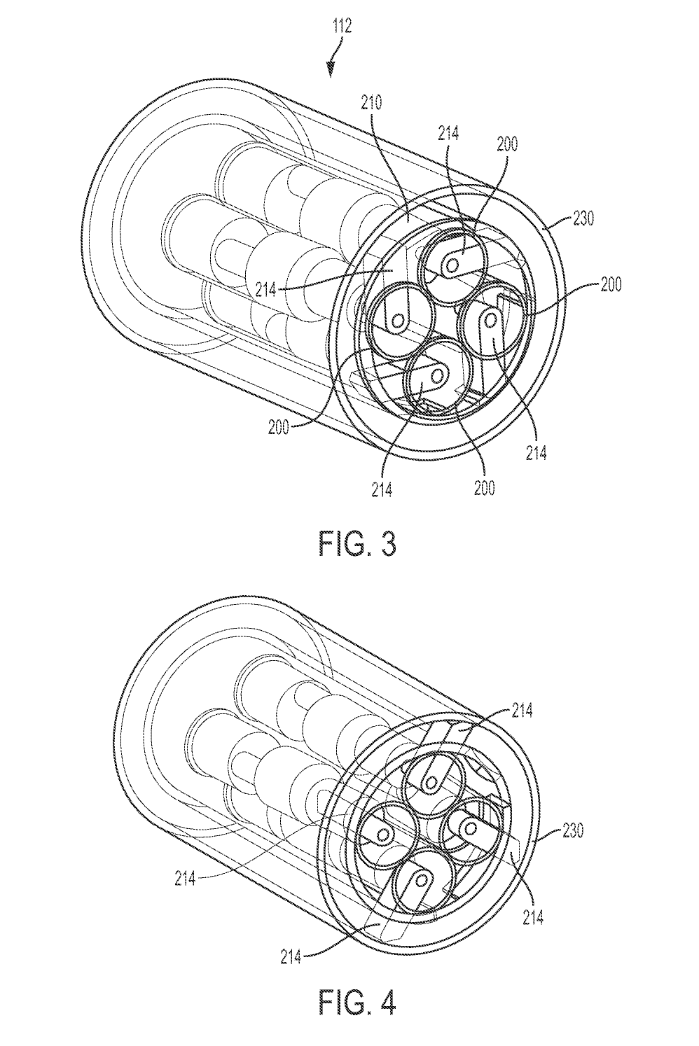

FIG. 2 is an illustration an actuation mechanism 200 of the source 112. In some aspects, the source 112 can include more than one actuation mechanism 200, for example as shown in FIGS. 3, 4. The actuation mechanism 200 can include a housing 202. The housing 202 can retain a motor 204. The motor 204 can be capable of rotation movement. The motor 204 can be a stepper motor with a position encoder or other suitable means of providing rotational motion. A solenoid 206 can be coupled to the motor 204. The solenoid 206 may also be coupled to a reduction drive, for example a planetary drive 208. The solenoid can engage and disengage the planetary drive 208 from the motor 204. In some aspects, the solenoid 206 can be mounted to the planetary drive 208 but not the motor 204. The planetary drive 208 can also be coupled to an energy storage device, for example torsion spring 210. The torsion spring 210 can be positioned on a rod or shaft 212. The torsion spring 210 can store rotational energy. The torsion spring 210 can unwind in response to the motor 204 being disengaged from the planetary drive 208. In some aspects, other types of springs or energy storage devices may be used.

A rigid body 214 can be positioned on an end of the shaft 212. The housing 202 can include an opening 218 sized to receive the rigid body 214. The rigid body 214 can have a retracted position. In the retracted position all or some of a contact end 216 of the rigid body 214 may be retracted within the housing 202. The rigid body 214 can have a deployed position. In the deployed position all or some of the contact end 216 of the rigid body 214 can project outside of the opening 218 of the housing 202. FIG. 2 shows the rigid body 214 in the deployed position. The contact end 216 of the rigid body 214 may contact the inner surface of a casing string (e.g., casing string 108) when the rigid body 214 is in the deployed position. The force of the contact end 216 of the rigid body 214 contacting the casing string as the rigid body 214 extends to the deployed position can create acoustic energy (i.e., a seismic vibration). In some aspects, the rigid body 214 can contact a striker plate instead of the casing string. The striker plate can be coupled to or separate from the source 112. For example, in an open hole well, a striker plate can be positionable proximate to each rigid body 214 of the source 112. The rigid body 214 of each actuation mechanism 200 can strike the strike plate to release acoustic energy. In some aspects, the striker plate can be retractable. In some aspects, the striker plate can act as a centralizer for the source 112 as it is positioned downhole.

The rigid body 214 can move from the retracted position to the deployed position. The rigid body 214 may return to the retracted position after being in the deployed position, and thus may be repeatedly retracted and deployed (or actuated). The rigid body 214 can include slots, grooves, or other features that can affect the frequency of the seismic vibration created when the rigid body 214 contacts the casing section. For example, a groove 220 in the rigid body 214 can affect the frequency of the seismic vibration of the contact end 216 of the rigid body 214 contacting the casing section.

The rigid body 214 can be comprised of rigid or semi-rigid materials, including but not limited to metal, carbon fiber, epoxy resin, or other suitably rigid materials. A desired frequency of the seismic vibration created by the rigid body 214 can be selected to produce a desired seismic vibration frequency when contacting the casing section through the selection of the shape of the rigid body 214, the material of the rigid body 214, and the size, shape and position of slots, grooves, or perforations in the rigid body 214.

The motor 204 can cause the torsion spring 210 to wind-up. The motor 204 can be coupled to the planetary drive 208. Thereby the motor 204 can be coupled to the torsion spring 210 via the planetary drive 208. The solenoid 206 can operate an engagement switch between the planetary drive 208 and the motor 204. In some aspects, the solenoid 206 can be mounted on the planetary drive 208 as opposed to the motor 204. The engagement switch can couple and decouple the planetary drive 208 from the motor 204, which can thereby uncouple the torsion spring 210 from the motor 204. The torsion spring 210 can unwind when uncoupled from the motor 204.

The motor 204 can include a torque measuring device. The torque measuring device can cause the motor 204 to stop winding the torsion spring 210 when a predetermined torque measurement has been reached. The predetermined torque measurement can be set from the surface of the wellbore. The predetermined torque measurement can correspond to a specific amount of energy that may be stored in the torsion spring 210. In some aspects, the motor 204 can include a brake that can hold the motor 204 in place when the predetermine torque measurement has been reached. The brake may be an electronically operated brake, though other suitable breaking means may be used.

The torsion spring 210 can release the rotational energy it has stored when the planetary drive 208 is decoupled from the torsion spring 210. The shaft 212 that the torsion spring 210 is mounted on can rotate in response to the rotation of the torsion spring 210 as it unwinds. The rigid body 214 that is mounted on the shaft 212 can also accelerate rotationally with the rotation of the shaft 212. The rigid body 214 can be accelerated and ejected outside the housing 202 through the opening 218. The contact end 216 of the rigid body 214 can strike the casing when the rigid body 214 is ejected outside the housing 202. An acoustic energy (i.e., a seismic vibration) can be released when the rigid body 214 strikes the casing. The acoustic energy can be released into the formation. The acoustic energy can be reflected back in the formation to be detected by receivers within the formation, for example seismic detectors 118 shown in FIG. 1. In some aspects, a rotational pressure seal may be positioned on the shaft 212 between the rigid body 214 and the torsion spring 210 and other components of the source.

The solenoid 206 may re-engage with the planetary drive 208 after release of the torsion spring 210. The motor 204 can again wind up the torsion spring 210. The winding of the torsion spring 210 can cause the rigid body 214 to rotate and retract back into the housing 202. The rigid body 214 may be repeatedly actuated by repeatedly winding and releasing the torsion spring 210. In some aspects, the rigid body 214 may include a ratchet and pawl mechanism that can allow the torsion spring 210 to wind up to a pre-determined amount before rotating and retracting the rigid body 214 back into the housing 202. In some aspects, the torsion spring 210 may be constructed so as to require less than one full turn to wind up the torsion spring 210 to a level associated with a desired acoustic energy.

A source 112 that includes a single actuation mechanism 200 can create a single point force upon striking the casing or a striker plate. A source may also generated near-field and intermediate-field radiation patterns. Near-field and intermediate-field radiation patterns may decay prior to reaching a receiver (e.g., geophone, EAT sensor, etc.). Near field seismic energy may be characterized by a 1/R³ amplitude decay, intermediate-field seismic energy may be characterized by a 1/R² amplitude decay, and far-field seismic energy may be characterized by a 1/R amplitude decay, where R is the distance from the source to the receiver.

An example of the radiation pattern in two dimensions (orthogonal to the borehole axis) of a single point force is provided below.

The seismic radiation pattern of a single point force can include P-waves that are at a maximum when aligned with the force direction. The seismic radiation pattern of the single point force can also include S-waves at a maximum value when the S-wave is orthogonal to the force direction. The amplitudes and angular dependence of the P and S-waves can be given by:

$${V}_{p} = \frac{F}{4 π ρ {α}^{2} R} cos θ {\hat{e}}_{R}$$

$${V}_{s} = \frac{F}{4 π ρ α {β}^{2} R} sin θ {\hat{e}}_{θ}$$

F is the force imparted, ρ is the density, α is the P-wave velocity, β is the S-wave velocity, R is the distance from the source, θ is the angle counterclockwise from the force direction to the receiver direction, and e_{R} and e_{θ} are unit vectors in the radial and tangential directions. There can be a sinusoidal patterns for both phases of these vectors.

A source (e.g., source 112) that includes two actuation mechanisms 200 may generate a point dipole. A point dipole has two equal forces pointed in the opposite directions, as shown in the figure below:

The amplitudes and angular dependence of these two waves are given by:

$${V}_{p} = \frac{Fd}{4 π ρ {α}^{3} R} {cos}^{2} θ {\hat{e}}_{R}$$

$${V}_{s} = \frac{Fd}{8 π ρ α {β}^{3} R} sin 2 θ {\hat{e}}_{θ}$$

In many cases, the term Fd may be written as a moment, M, where a point force actually has d→0, where d is the distance between the applied forces and F is the force imparted and F→∞, but such that M=Fd. In the figure shown above, where two actuation mechanisms 200 are deployed, there is a clear separation distance and force that can be used in any calculation, but the results will still look like a point dipole in the far field. As shown above, there is now a 2θ dependence for the S-wave, which may also have an amplitude that is reduced by a factor of two. The point dipole shown above results in S-waves on all of the 45 degree directions and P waves on the axis.

These mathematical principals can be used to select the amplitude, sequence, and rate (or timing) of the deployment of one or more actuation mechanisms to create an acoustic energy (e.g., seismic vibration) having certain desired characteristics. For example, an acoustic energy wave having a desired direction can be generated based on the amplitude, sequence, and rate of the deployment of the actuation mechanisms based on the principles outlined above.

FIG. 3 shows a source 112 according to an aspect of the disclosure that includes multiple actuation mechanisms 200. FIG. 3 shows the rigid bodies 214 of the actuation mechanisms 200 in the retracted position within a casing 230. FIG. 4 shows the rigid bodies 214 of the actuation mechanisms in the deployed position within a casing, in which the rigid bodies 214 contact an inner surface of the casing 230. The actuation mechanisms 200 can each be deployed individually, can be deployed together, or can be deployed in sequence.

The torsion spring 210 of each actuation mechanism 200 may be rotated to store a different amount of energy, corresponding to a different acoustic energy released by each actuation mechanism. For example, the rigid body 214 of each actuation mechanism 200 can thereby strike an inner surface of the casing 230 at various speed and energy levels that may result in varying amplitudes of acoustic energy (e.g., the seismic vibration). The source 112 can include a microprocessor that can be communicatively coupled to a controller at the surface. The controller can instruct the microprocessor regarding the amplitude, sequence, and rate of deployment of the actuation mechanisms 200 of the source 112. The amplitude can correspond to the force with which the rigid body 214 of an actuation mechanism 200 strikes the casing 230. The amplitude may correspond to the amount of torque stored in the torsion spring 210. The sequence can be the order in which the various actuation mechanism 200 are deployed. The rate can be the timing when each of the actuation mechanisms 200 are deployed relative to each other. The combined acoustic energy vector created by the deployment of the actuation mechanisms 200 can be determined based on the amplitude, sequence, and rate of the deployment of each of the actuation mechanisms 200.

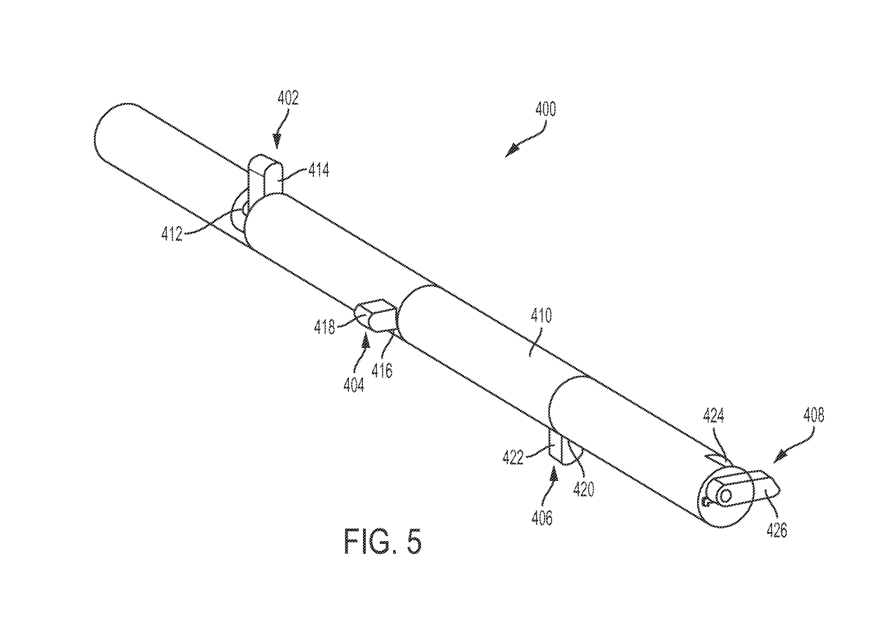

FIG. 5 shows an aspect of the disclosure in which a source 400 includes four actuation mechanisms 402, 404, 406, 408 positioned in series with one another. Each of the actuation mechanisms 402, 404, 406, 408 can function as described with respect to actuation mechanism 200. The source 400 can include a housing 410 that contains each of the actuation mechanisms 402, 404, 406, 408. The housing 410 can include an opening 412 through which a rigid body 414 of the actuation mechanism 402 may extend when deployed. The housing 410 can include an opening 416 through which a rigid body 418 of the actuation mechanism 404 may extend when deployed. The housing 410 can include an opening 420 through which a rigid body 422 of an actuation mechanism 406 may extend when deployed. The housing can also include an opening 424 through which a rigid body 426 of the actuation mechanism 408 may extend when deployed.

The source 400 can include a microprocessor that may be in communication with a controller positioned at the surface. The microprocessor may control the actuation mechanisms 402, 404, 406, 408, for example the rigid bodies 414, 418, 422, 426. The rigid bodies 414, 418, 422, 426 may be deployed to strike a casing or a striker plate individually, together, or in a desired sequence or order. As shown in FIG. 5, the rigid bodies 414, 418, 422, 426, in their deployed positions, extend in various directions. In some aspects, the rigid bodies 414, 418, 422, 426 and the corresponding openings 412, 416, 420, 424 may be positioned in other directions as desired based on the specific wellbore the source 400 is positioned within.

The multiple actuation mechanisms 402, 404, 406, 408 can provide multiple point forces on the sides of the wellbore in which the source 400 is positioned via the rigid bodies 414, 418, 422, 426. The multiple point forces provided by the multiple actuation mechanisms 402, 404, 406, 408 can provide the potential to modify the P and S-waves generated by deployment of the rigid bodies 414, 418, 422, 426 to achieve a desired seismic vibration. A seismic vibration having a desired direction can be generated based on the amplitude, sequence, and rate (i.e., timing) of the deployment of the actuation mechanisms. In some aspects, the source 400 can be used to generate an S-wave with high energy levels.

FIG. 6 is a block diagram of a system 500 that includes a source, for example source 400. The source 400 can be communicatively coupled to a computing device, for example controller 113 at the surface of the wellbore. The source 400 can include a microprocessor 502 that can control each of the actuation mechanisms 402, 404, 406, 408. The microprocessor 502 can be communicatively coupled to the controller 113 via the communication link, for example wireline 114. The controller 113 can determine the amplitude, sequence, and rate of the actuation mechanisms 402, 404, 406, 408 based on the characteristics of a desired acoustic energy. For example, the type of wave (S or P-wave), frequency of the wave, direction of the wave, and other characteristics of the acoustic energy that may be controlled based on the amplitude, sequence, and rate of the deployment of the source 400. The controller 113 can instruct the microprocessor 502 on the amplitude, sequence, and rate of each of the actuation mechanisms 402, 404, 406, 408 to create the desired acoustic energy. For example, the controller 113 can instructor the microprocessor 502 on which actuation mechanism to deploy, when to deploy it, and at what force it should be deployed. In some aspects, the source 400 can also include a sensor 506, for example a gyrometer, inclinometer, or accelerometer. The sensor 506 can determine the orientation of the source 400 and can transmit that information to the microprocessor 502. The microprocessor 502 can transmit the orientation information to the controller 113 for use in determining the desired amplitude, sequence, and rate of each of the actuation mechanisms 402, 404, 406, 408.

The controller 113 can be in communication with another computing device, for example a computing device that is part of a DAS system 508. The controller 113 can transmit to the DAS system 508 information related to the amplitude, sequence, and rate selected. For example, the controller 113 can transmit to the DAS system 508 information regarding which actuation mechanism of the source 400 is deployed and at what time and at what force. In some aspects, the controller 113 can also transmit to the DAS system 508 information regarding the orientation of the source 400 based on the information provided by the sensor 506. The controller 113 can be communicatively coupled to the DAS system 508 by a communication link 510. The communication link 510 could be a wired communication link or a wireless communication link.

A source of acoustic energy, for example the source 400 can be used to generate a desired acoustic energy pattern for both P and S waves for the far-field radiation pattern. As described above, a source having multiple actuation mechanisms or rigid bodies may also generated near-field and intermediate-field radiation patterns. A source having four actuation mechanisms, for example the source 400 or the source 112 shown in FIGS. 3, 4, can create a point quadrapole. A point quadrapole can have two sets of point dipoles, with one dipole orthogonal to the other, as shown in the figure below.

This source, having four actuation mechanisms can result in P-waves that constructively interfere. The source can also result in S-waves that destructively interfere, resulting in a P-wave source only in the far field. The point quadrapole can be described by the following equations:

$${V}_{p} = \frac{Fd}{4 π ρ {α}^{3} R} {\hat{e}}_{R}$$

$${V}_{s} = 0$$

In the above equation, F is the force imparted, ρ is the density, α is the P-wave velocity, β is the S-wave velocity, R is the distance from the source, θ is the angle counterclockwise from the force direction to the receiver direction, and e_{R} and e_{θ} are unit vectors in the radial and tangential directions, and d is the distance between the forces in each of the two dipoles. Based on the descriptions above, a point force or a force dipole can produce a strong S-wave while the point quadrapole can provide a strong P-wave.

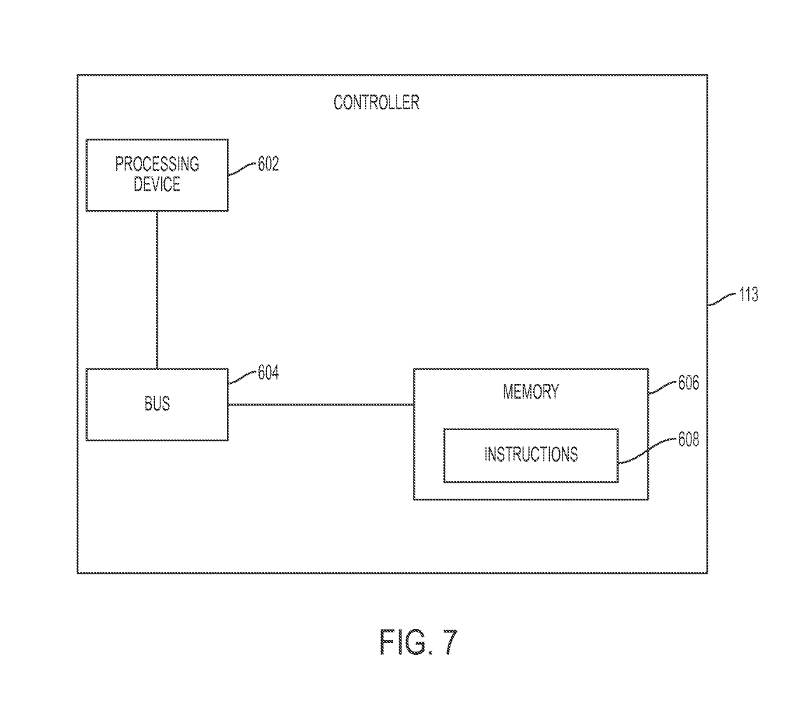

FIG. 7 is a block diagram depicting an example of a computing device, for example controller 113, for determining the amplitude, sequence, rate of the deployment of the actuation mechanisms of a source, according to one aspect of the present disclosure. The controller 113 includes a processing device 602, a memory device 606, and a bus 604.

The processing device 602 can execute one or more operations for calculating a desired acoustic energy. The processing device 602 can execute instructions 608 stored in the memory device 606 to perform the operations. The processing device 602 can include one processing device or multiple processing devices. Non-limiting examples of the processing device 602 include a Field-Programmable Gate Array (“FPGA”), an application-specific integrated circuit (“ASIC”), a microprocessor, etc.

The processing device 602 can be communicatively coupled to the memory device 606 via the bus 604. The non-volatile memory device 606 may include any type of memory device that retains stored information when powered off. Non-limiting examples of the memory device 606 include EEPROM, flash memory, or any other type of non-volatile memory. In some aspects, at least some of the memory device 606 can include a medium from which the processing device 602 can read the instructions 608. A computer-readable medium can include electronic, optical, magnetic, or other storage devices capable of providing the processing device 602 with computer-readable instructions or other program code. Non-limiting examples of a computer-readable medium include (but are not limited to) magnetic disk(s), memory chip(s), ROM, RAM, an ASIC, a configured processor, optical storage, or any other medium from which a computer processor can read instructions. The instructions may include processor-specific instructions generated by a compiler or an interpreter from code written in any suitable computer-programming language, including, for example, C, C++, C#, etc.

### Example #1

A source of acoustic energy for a downhole environment can include a motor and a mechanical energy storage device for storing a preset amount of torque generated by the motor. The source can also include a rigid body moveable between a retracted position and an extended position by the mechanical energy storage device. The rigid body may be for releasing the acoustic energy into the downhole environment in response to the mechanical energy storage device releasing the preset amount of torque generated by the motor and moving the rigid body into the extended position.

### Example #2

The source of Example #1 may further feature the rigid body being moveable from the extended position to the retracted position in response to the mechanical energy storage device storing the present amount of torque generated by the motor.

### Example #3

The source of any of Examples #1-2 may further feature the mechanical energy storage device being a torsion spring.

### Example #4

The source of any of Examples #1-3 may further feature a reduction drive that is coupleable and de-coupleable to the motor.

### Example #5

The source of Example #4 may further feature a solenoid for coupling and decoupling the reduction drive to the motor in response to a signal.

### Example #6

The source of Example #5 may further feature a microprocessor for controlling the solenoid by transmitting the signal.

### Example #7

The source of any of Examples #1-5 may further feature the rigid body being releasing the acoustic energy into the downhole environment by contacting an inner region of a casing when in the extended position.

### Example #8

The source of any of Examples #1-7 may further feature a sensor for determining an orientation of the source.

### Example #9

The source of any of Examples #1-8 may further feature an additional rigid body for producing a an additional acoustic energy.

### Example #10

A system may include a computing device for determining characteristics of a first acoustic energy for release in a downhole environment and a second acoustic energy for release in the downhole environment. The first acoustic energy and the second acoustic energy may be combined to form a desired acoustic energy. The system can include a source having a first rigid body coupled to a first spring. The first rigid body may be moveable between a first retracted position and a first extended position. The first rigid body may be for producing the first acoustic energy in response to the first spring releasing a first amount of stored energy. The source may also include a second rigid body coupled to a second spring and moveable between a second retracted position and a second extended position. The second rigid body may be for producing the second acoustic energy in response to the second spring releasing a second amount of stored energy. The system can also include at least one receiver for monitoring the desired acoustic energy released in the downhole environment.

### Example #11

The system of Example #10 may further feature the characteristics of the first acoustic energy including a time the first acoustic energy is released downhole and the characteristics of the second acoustic energy including a time the second acoustic energy is released downhole.

### Example #12

The system of any of Examples #10-11 may feature the characteristics of the first acoustic energy including an amplitude of the first acoustic energy and the characteristics of the second acoustic energy including an amplitude of the second acoustic energy.

### Example #13

Any of the systems of Examples #10-12 may further feature the at least one receiver being an electro acoustic technology sensor for converting an electrical signal into a frequency that drives an acoustic signal.

### Example #14

Any of the systems of Examples #10-13 may further feature an optical fiber positioned in a second downhole environment for receiving an acoustic signal from the at least one receiver and transmitting the acoustic signal to an electro acoustic technology system at a surface.

### Example #15

Any of the systems of Examples #10-14 may further further a communication link coupling the source to the computing device. The communication link may also provide electrical power to the source.

### Example #16

An assembly may include a first actuation mechanism comprising a first motor, a first torsion spring, and a first rigid body controllable by the first torsion spring for releasing a first acoustic energy into a downhole environment. The assembly may also include a second actuation mechanism comprising a second motor, a second torsion spring, and a second rigid body controllable by the second torsion spring for releasing a second acoustic energy into the downhole environment. The first actuation mechanism and the second actuation mechanism may be oriented relative to each other for producing a combined acoustic energy when the first actuation mechanism releases the first acoustic energy and the second actuation mechanism releases the second acoustic energy.

### Example #17

The assembly of Example #16 may further feature the first rigid body being oriented at a ninety degree angle from the second rigid body for producing a point dipole that is the combined acoustic energy.

### Example #18

The assembly of any of Examples #16-17 may further feature a sensor for determining an orientation of the first actuation mechanism and the second actuation mechanism.

### Example #19

The assembly of any of Examples #16-18 may further feature a third rigid body, and a fourth rigid body. The first rigid body, the second rigid body, the third rigid body, and the fourth rigid body may be positioned at approximately ninety degree increments about a central axis for producing a point quadrapole that is the combined acoustic energy.

### Example #20

The assembly of any of Examples #16-19 may further feature a microprocessor for controlling the first actuation mechanism and the second actuation mechanism.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A source of acoustic energy for a downhole environment, the source comprising:
a motor;
a mechanical energy storage device for storing a preset amount of torque generated by the motor; and
a rigid body moveable between a retracted position and an extended position by the mechanical energy storage device, the rigid body being for releasing the acoustic energy into the downhole environment in response to the mechanical energy storage device releasing the preset amount of torque generated by the motor and moving the rigid body to the extended position.

2. The source of claim 1, wherein rigid body is moveable from the extended position to the retracted position in response to the mechanical energy storage device storing the present amount of torque generated by the motor.

3. The source of claim 1, wherein the mechanical energy storage device is a torsion spring.

4. The source of claim 1, further comprising a reduction drive that is coupleable and de-coupleable to the motor.

5. The source of claim 4, further comprising a solenoid for coupling and decoupling the reduction drive to the motor in response to a signal.

6. The source of claim 5, further comprising a microprocessor for controlling the solenoid by transmitting the signal.

7. The source of claim 1, wherein the rigid body releases the acoustic energy into the downhole environment by contacting an inner region of a casing when in the extended position.

8. The source of claim 1, further comprising a sensor for determining an orientation of the source.

9. The source of claim 1, further comprising an additional rigid body for producing a an additional acoustic energy.

10. A system comprising:
a computing device for determining characteristics of a first acoustic energy and a second acoustic energy for release in a downhole environment to combined form a desired acoustic energy;
a source including:
a first rigid body coupled to a first spring and moveable between a first retracted position and a first extended position, the first rigid body for producing the first acoustic energy in response to the first spring releasing a first amount of stored energy; and
a second rigid body coupled to a second spring and moveable between a second retracted position and a second extended position, the second rigid body for producing the second acoustic energy in response to the second spring releasing a second amount of stored energy;
at least one receiver for monitoring the desired acoustic energy released in the downhole environment.

11. The system of claim 10, wherein the characteristics of the first acoustic energy and the characteristics of the second acoustic energy include a time the first acoustic energy is released downhole and a time the second acoustic energy is released downhole.

12. The system of claim 10, wherein the characteristics of the first acoustic energy and the characteristics of the second acoustic energy include an amplitude of the first acoustic energy and an amplitude of the second acoustic energy.

13. The system of claim 10, wherein the at least one receiver is an electro acoustic technology sensor for converting an electrical signal into a frequency that drives an acoustic signal.

14. The system of claim 10, further comprising an optical fiber positioned in a wellbore for receiving an acoustic signal from the at least one receiver and transmitting the acoustic signal to an electro acoustic technology system at a surface.

15. The system of claim 10, further comprising a communication link coupling the source to the computing device, wherein the communication link also provides electrical power to the source.

16. An assembly comprising:
a first actuation mechanism comprising a first motor, a first torsion spring, and a first rigid body controllable by the first torsion spring for releasing a first acoustic energy into a downhole environment; and
a second actuation mechanism comprising a second motor, a second torsion spring, and a second rigid body controllable by the second torsion spring for releasing a second acoustic energy into the downhole environment,
wherein the first actuation mechanism and the second actuation mechanism are oriented relative to each other for producing a combined acoustic energy when the first actuation mechanism releases the first acoustic energy and the second actuation mechanism releases the second acoustic energy.

17. The assembly of claim 16, wherein the first rigid body is oriented at a ninety degree angle from the second rigid body for producing a point dipole that is the combined acoustic energy.

18. The assembly of claim 16, further comprising a sensor for determining an orientation of the first actuation mechanism and the second actuation mechanism.

19. The assembly of claim 16, further comprising a third rigid body, and a fourth rigid body, wherein each of the first rigid body, the second rigid body, the third rigid body, and the fourth rigid body are positioned at approximately ninety degree increments about a central axis for producing a point quadrapole that is the combined acoustic energy.

20. The assembly of claim 16, wherein the assembly includes a microprocessor for controlling the first actuation mechanism and the second actuation mechanism.
